(19) United States
(12) Patent Application Publication
(10) Pub. No.: US 2022/0126198 A1
(43) Pub. Date: Apr. 28, 2022

(54) Gaming Vest

(71) Applicant: Christian Toro, North Las Vegas, NV (US)

(72) Inventor: Christian Toro, North Las Vegas, NV (US)

(21) Appl. No.: 17/209,353

(22) Filed: Mar. 23, 2021

Related U.S. Application Data
(60) Provisional application No. 63/106,617, filed on Oct. 28, 2020.

(51) Int. Cl. A63F 13/285; A63F 13/212

(52) U.S. Cl. CPC A63F 13/285; A63F 2300/302; A63F 13/212

(57) ABSTRACT

This present invention relates to a modified video game and virtual reality control system configured as a gaming vest. The gaming vest comprises various sensors to detect a user's upper body movements and accordingly mimics the movements for any character in the video game. The sensors, such as motion sensors, detect forward, backward, rotational, lateral or other spatial movements. The sensors further detect angle inclinations and relative rotation of the chest and shoulders of the user to correspond with an in-game movement. The present invention also offers a unique control system for both video games and virtual reality simulations.

### CROSS-REFERENCE TO RELATED APPLICATION

The present application claims priority to, and the benefit of, U.S. Provisional Application No. 63/106,617, which was filed on Oct. 28, 2020 and is incorporated herein by reference in its entirety.

### FIELD OF THE INVENTION

The present invention relates generally to the field of video game controllers. More specifically, the present invention relates to an improved gaming and virtual reality controller configured as a vest. The gaming vest of the present invention features several motion detecting sensors capable of identifying angle inclinations of chest and shoulder movements to correspond to (i.e. mimic) in-game movements. The gaming vest comprises a harness or framing mechanism to support the vest and the associated sensors on the body in a comfortable manner. Additionally, the gaming vest can be easily worn by a player to control in-game movements. Accordingly, the present disclosure makes specific reference thereto. Nonetheless, it is to be appreciated that aspects of the present invention are also equally amenable to other like applications and video games controlling means.

### BACKGROUND OF THE INVENTION

By the way of background, various video games are available in the market for the fun and entertainment of the individual playing the games. In one basic arrangement, a video game is an indoor electronic game that can include an interaction between a player and an interface/input device. The interface or input device can be an assembly such as a joystick, a controller, a mouse, a keyboard, a video game console remote control or a motion sensing device. The interface device can generate visual feedback on a screen for the player and control or mimic in-game movements of the player on the screen. The visual feedback can be shown on a video display device, such as a television, monitor, smartphone screen, touch screen, a projector or the like. Additionally, video games are sometimes controlled or played with the aid of audio feedback delivered through speakers or headphones. Further, video games can include other components that provide various types of feedback, such as touch sensor technology.

Video games are a very popular form of entertainment among people of all ages. Technological improvements in recent video games include three dimensional views, virtual reality and other enhancements that provide increasingly realistic characteristics to the perception of the players. Present versions of video games include the use of famous action heroes and more advanced vehicles. Additionally, video games now have improved sound and vibration effects. Advanced video game joystick controllers incorporate interactive features that provide the user with a ‘similar’ feel of different vibrations and other stimuli experienced in a simulated manner by the action hero, vehicle or other character during game play. Traditional game controllers, such as keyboards or remote control devices can be used to manipulate and control the activities of the players. However, there exists a long felt need in the art for more unique and engaging play styles for interactive video games.

Advancements in the gaming industry have provided developments incorporating technologies such as augmented reality (AR) that adds digital elements to a live view and virtual reality (VR) that provides a complete game immersion experience. VR involves a computer-generated simulation in which a player can interact within an artificial three-dimensional environment using electronic devices such as special goggles having a particularly adapted screen. However, games incorporating VR may be limited to just observation without a uniquely designed controller system to intricately manipulate in-game movements of a participant, character or player. Many of the pre-existing game controllers, heretofore known, are not compatible with VR games.

Therefore, there exists a long felt need in the art for a unique game controller that can be used by individuals, users or “garners” to play VR games. There also exists a long felt need in the art for a virtual reality controller, instead of just goggles, that can be easily used to control in-game movements. Additionally, there is a long felt need in the art for a VR device and gaming control system that can be worn in a comfortable manner, thereby allowing users to play games for a considerable amount of time without experiencing discomfort. Further, there is a long felt need in the art for a gaming and virtual reality controller that allows players to more intricately manipulate on-screen characters as required. Furthermore, there is a long felt need in the art for a gaming controller device that is interesting and entertaining for the user. Additionally, there is a long felt need in the art for a more realistic virtual reality experience while playing video games. Finally, there is a long felt need in the art for an improved virtual reality control system that enables a player's movements to be captured and translated simultaneously to the game engine while the virtual reality game is being played.

The subject matter disclosed and claimed herein, in one embodiment thereof, comprises a gaming vest that functions as a virtual reality control system. More specifically, the gaming vest can comprise a vest-shaped structure having a plurality of motion sensors integrated within the chest and the shoulder areas of the vest structure. A user, while wearing the vest, can control their in-game movements via respective movements of the chest and shoulders and their associated motion sensors. The motion sensors positioned over the chest and shoulder areas can detect angle inclinations and/or rotations of the chest and shoulder movements of the player that correspond with in-game movements. The sensors can detect, for example, rotational, lateral, forward and backward movements of the upper body. Accordingly, the movements can be mimicked in the on-screen game. The gaming vest features a harness or frame to support the vest, and sensors on the body positioned in a comfortable manner, thereby allowing the users to play games for a considerable amount of time without discomfort. Additionally, the gaming vest features a belt to secure it firmly to the user's body during play.

In this manner, the gaming vest with integrated sensors of the present invention accomplishes all of the forgoing objectives, and provides a gaming and virtual reality control system for playing video games that uses the movements of the user to control/manipulate in-game movements of a character, action hero, vehicle, etc. in the on-screen game. The gaming vest of the present invention is designed with a variety of sensors and control features installed in the vest that provides a fun-filled, enhanced experience for the user. Additionally, the gaming vest of the present invention is user-friendly, inasmuch it provides full comfort to the wearer, thereby allowing the wearer to play games for a considerable amount of time without discomfort.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a gaming vest that is designed to function as a virtual reality control system. The gaming vest preferably comprises a vest or harness-shaped structure having a plurality of motion sensors integrated within the chest and shoulder areas of the vest structure. A user, while wearing the vest, can control their in-game movements via actual movements of the chest and shoulders. The motion sensors, positioned over the chest and shoulder areas, detect intricate angle inclinations and rotations of the player's respective chest and shoulder movements that can be translated and transmitted to correspond with in-game movements. The sensors detect rotational, lateral, forward and backward movement of the upper body, and accordingly said movements are mimicked in the on-screen game. The gaming vest features a framing or harness architecture to support the vest and comfortably placed sensors on the body, thereby allowing users to play games for an extended amount of time. Additionally, the gaming vest features a belt to firmly secure it to the user's body during play.

In a preferred embodiment of the present invention, a gaming and virtual reality control system is disclosed. The gaming and virtual reality control system comprises a framing structure for supporting the system over a user's body, a plurality of sensors for detecting any chest/shoulder movements of the user, a processor for interpreting the sensor data, a communication module for transmitting the sensor data to a display screen, a memory for storing data and a battery for supplying power to the system.

In another embodiment of the present invention, a method of using a gaming vest to play a video game is disclosed. The method comprises the steps of wearing the gaming vest by placing the top portion of the user's shoulders, fastening a belt of the vest to secure the vest to the user's body, performing rotational, lateral, forward and backward movement using the upper body, identifying chest and shoulder movements using sensors positioned over the chest and shoulder regions of the vest and mimicking the identified movements in the game.

In a further embodiment of the present invention, the gaming vest is constructed using silicone or any other suitable material. By way of structure, the gaming vest comprises a harness structure to support the gaming vest over a user's body and includes a belt to firmly secure the gaming vest to the user's body. Exact size, measurement, construction, and design specifications may vary upon further development and manufacturing of the vest.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of the gaming vest of the present invention in accordance with the disclosed architecture;

FIG. 2 illustrates a front perspective view of one potential embodiment of the gaming vest of the present invention in accordance with the disclosed architecture, wherein the gaming vest is being worn by a user;

FIG. 3 illustrates a rear perspective view of one potential embodiment of the gaming vest of the present invention in accordance with the disclosed architecture;

FIG. 4 illustrates a rear perspective view of one potential embodiment of the gaming vest of the present invention in accordance with the disclosed architecture, wherein the gaming vest is being worn by a user;

FIG. 5 illustrates a schematic view of one potential embodiment of the gaming vest with integrated sensor components of the present invention in accordance with the disclosed architecture;

FIG. 6 illustrates different actions being performed and detected via the sensors of the gaming vest of the present invention worn by the user in accordance with the disclosed architecture;

FIG. 7 illustrates a perspective view of the gaming vest of the present invention worn by the user to play a video game in accordance with the disclosed architecture; and

FIG. 8 illustrates a block diagram of one potential embodiment of the method of using the components of the gaming vest with integrated sensors of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a unique game controller that can be used by individuals or “garners” to play virtual reality games. There is also a long felt need in the art for a gaming and virtual reality controller that can be easily used to control in-game movements. There is also a long felt need in the art for a virtual reality and gaming control system that can be worn in a comfortable manner, thereby allowing users to play games for a considerable amount of time. Further, there is a long felt need in the art for a gaming and virtual reality controller that allows players to manipulate on-screen characters as desired. Furthermore, there is a long felt need in the art for a gaming controller device that is interesting and entertaining. Additionally, there is a long felt need in the art for proving users with a more realistic virtual reality experience while playing video games. Finally, there is a long felt need in the art for an improved virtual reality control system that enables a player's movements to be captured and translated to the game engine while playing VR games.

The innovative product of the present invention features a gaming vest in the form of a modified video game and virtual reality control system. The virtual reality control system, i.e. the gaming vest of the present invention, comprises a harness or vest with an integrated motion sensor system that a player can wear to play a VR mimicking video game. While wearing the vest, players can control their in-game movements via movements of the chest and shoulders and can experience an enhanced virtual world while playing a video game.

The present invention, in one exemplary embodiment, is a gaming vest which is a modified video game and virtual reality control system. The gaming vest comprises a vest-shaped structure having a plurality of motion sensors integrated within the chest and shoulder areas of the harness. A user wearing the vest controls their in-game movements via movement of the chest and shoulders. The motion sensors positioned over the chest and shoulder area detect angle inclinations and relative rotations of the user's chest and shoulder movements to correspond with in-game movements. The sensors, for example, detect rotational, lateral, forward and backward movements of the upper body, wherein the movements are mimicked in the on-screen game accordingly. The gaming vest features a frame or harness architecture to support the vest, and sensors comfortably placed on the body, thereby allowing users to play games for a considerable amount of time. Additionally, the gaming vest features a belt to secure it firmly to the user's body while playing the game.

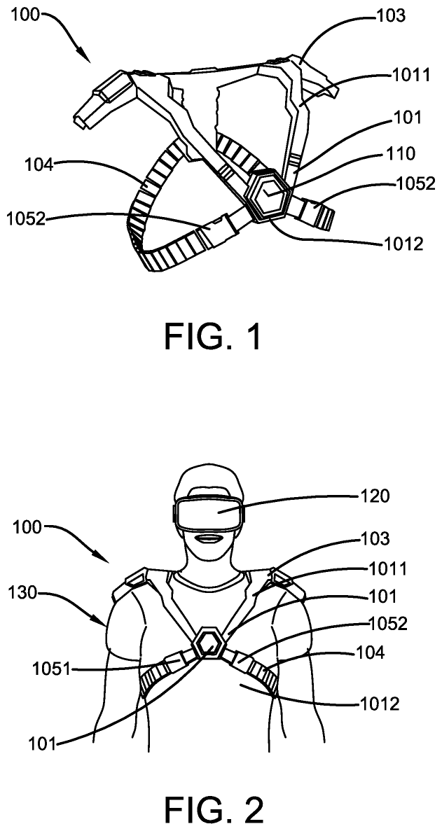

Referring initially to the drawings, FIG. 1 illustrates a front perspective view of a gaming vest 100 of the present invention in accordance with the disclosed architecture. The gaming vest 100 of the present invention can be configured as a vest or harness-shaped structure having a front portion 101, a rear portion 102 (not shown), a top portion 103 and an elongated belt 104. The front portion 101 of the gaming vest 100 comprises an upper front portion 1011 and a lower front portion 1012, wherein the upper front portion 1011 comprises a frame support for the user's shoulders having integrated sensors to detect upper body movements of the user, and the lower front portion 1012 comprises the elongated belt 104 which is adapted to encircle the wearer's waist when the vest 100 is worn. Further, the vest 100 comprises a chest motion-detection or center sensor panel 110 positioned at the front central portion of the vest 100. It is to be appreciated that the center sensor panel 110 can be proximal to a user's bodily center of gravity. Bodily center of gravity is typically described as slightly below the navel and centered within a person's body. The belt 104 comprises a right fastener 1051 and a left fastener 1052 to firmly secure the vest 100 around the waist of the user. The fasteners 1051, 1052 of the belt 104 can be, in one exemplary embodiment, adjustable side-release plastic buckles. The belt fastening mechanism is not limited to plastic buckles and other fastening mechanisms can be used such as, without limitation, a snap, a button, a magnet, and a hook and loop fastener.

The gaming vest 100 of the present invention is manufactured using a suitable material selected from, but not limited to, metal, fabric, foam, rubber, silicone or other similar materials. In one preferred embodiment, the gaming vest 100 is made up of silicone. The belt 104 may be constructed of a rubber, a fabric, a plastic, a leather or other suitable material.

FIG. 2 illustrates a front perspective view of a user wearing the gaming vest of the present invention in accordance with the disclosed architecture. As shown, the gaming vest 100 is worn by a user 130 such that the upper front portion 1011 remains in contact with the upper chest of the user 130 and the lower front portion 1012 remains in contact with the lower chest/ribs of the user. Additionally, when the vest 100 is properly secured to a user's body, the chest motion detection panel 110 is generally positioned over the chest region of the user 130 to capture any movements associated with the chest through the sensors placed inside the panel 110.

The user 130 can also wear a Virtual Reality (VR) Box 120 over the eyes to visualize the virtual game more realistically. VR Box 120 is a head-mounted device that the user 130 wears over his or her eyes like a pair of goggles. The VR box 120 provides an immersive virtual reality experience for the users.

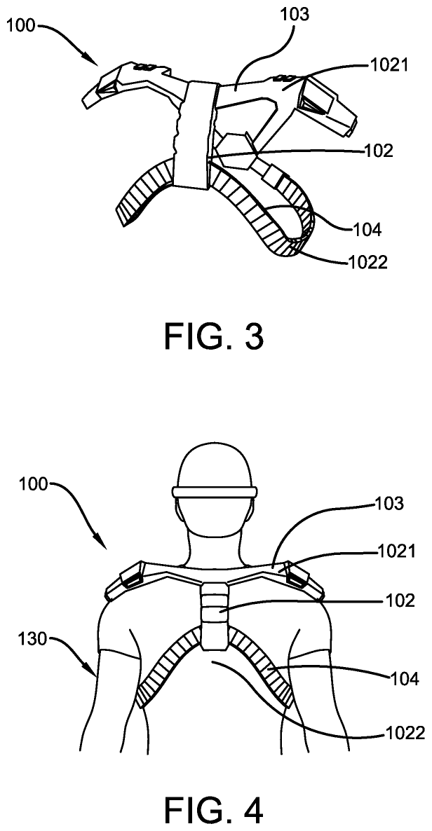

FIG. 3 illustrates a rear perspective view of the gaming vest of the present invention in accordance with the disclosed architecture. The rear portion 102 of the vest comprises an upper rear portion 1021 covering the back and a lower rear portion 1022 with an elongated belt 104 encircling the back of the user.

FIG. 4 illustrates a rear perspective view of the user 130 wearing the gaming vest of the present invention in accordance with the disclosed architecture. The gaming vest 100 of the present invention, when worn by a user 130, retains the rear portion 102 in contact with the back of the user 130. The elongated belt 104 circles around the user's waist to grip the vest 100 around the body of the user 130.

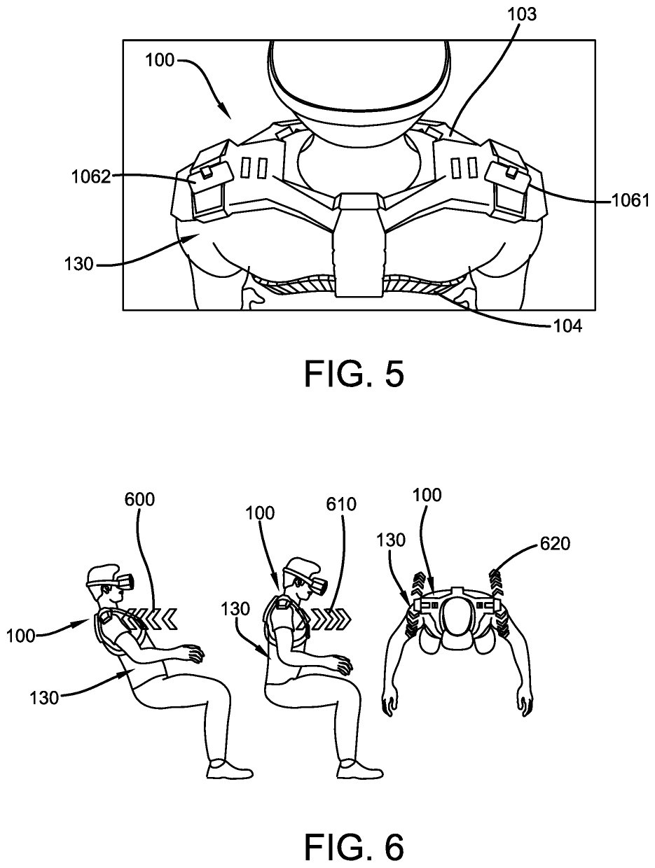

FIG. 5 illustrates a schematic view of sensor components of the gaming vest of the present invention in accordance with the disclosed architecture. As shown in FIG. 5, the top portion 103 of the gaming vest 100 lies over the shoulders of the user 130. The top portion 103 features, in one exemplary embodiment, a metallic structure comprising a right sensor panel 1061 and a left sensor panel 1062. The right sensor panel 1061 is present on the right side of the top portion 103 of the gaming vest 100 and the left sensor panel 1062 is present on the left side of the top portion 103 of the gaming vest 100. When the gaming vest 100 is worn by the user 130, the right sensor panel 1061 lies over the right shoulder and the left sensor panel 1062 lies over the left shoulder of the user 130.

The right sensor panel 1061 and the left sensor panel 1062 comprise a plurality of motion sensors to detect any movement made by the shoulders of the user 130. The sensors in the panels 1061 and 1062 detect angles of inclination, and axial rotations, relative to one another and relative to the chest motion detection panel 110 whereby respective user movements can translate to in-game movements. The sensors detect upper body rotational, lateral, forward and backward movements in order to mimic the movements in the game.

FIG. 6 illustrates different actions being performed via the sensors of the gaming vest of the present invention worn by the user in accordance with the disclosed architecture. Various sensors placed on the right sensor panel 1061, left sensor panel 1062 and chest motion detection panel 110 detect angles of inclination of each of the user's chest and shoulder movement to correspond with in-game movements. The sensors on the right sensor panel 1061, left sensor panel 1062 and chest motion detection panel 110 detect rotational, lateral, forward and backward movement with the upper body and accordingly process the movements to mimic the same within an on-screen game.

As shown in FIG. 6, the user 130 wearing the gaming vest 100 can move, for example, in a backward direction 600. The sensors 110 , 1061, and 1062 of the vest 100 can collect the motion data by detecting the backward movement 600 of the user 130. When the user 130 moves in a forward direction 610, the sensors on various panels of the vest 100 worn by the user 130 collects the motion data by detecting the forward movement 610. Additionally, when the user 130 makes lateral movements 620, corresponding motion data is collected by the sensors by detecting and mimicking the user's lateral movements 620.

Based on the detected movements such as 600, 610, 620 or more, corresponding movements are mimicked in the on-screen game played by the user. The game controller 100 of the present invention enables the user to participate in virtual reality games in an improved, fun and entertaining manner.

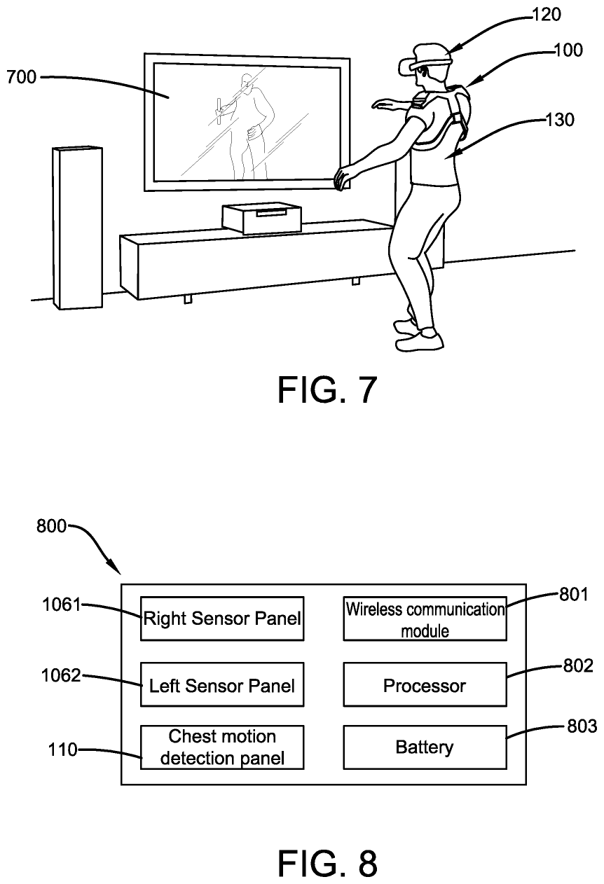

FIG. 7 illustrates a perspective view of the gaming vest of the present invention worn by the user to play a video game in accordance with the disclosed architecture. A user 130 wearing the gaming vest 100 of the present invention can control their in-game movements via movement of their own chest and shoulders. The sensors in the right sensor panel 1061, left sensor panel 1062 and the chest motion detection panel 110 collect the motion data from any movements of the user's 130 upper body, including the chest and shoulders. Once the data is collected by the sensors, the collected data is transmitted to a processor for processing and detecting the movements. Accordingly, the detected movements such as rotational, lateral, forward, backward, or other type of movements by the upper body, can be translated and mimicked in the on-screen game. The imitation of the user's movements can be viewed on the television unit 700, or any other device such as, but not limited to, a projector, monitor, display unit or the like.

It is to be appreciated that in Euclidean space, a plane can be uniquely determined by three non-collinear points (points not on a single line). Alternatively, a plane can be uniquely determined by a line and a point not on that line. Further, it is to be appreciated that any two points can define a line.

Similarly, the sensors 110, 1061, 1062 can define three non-collinear points. Thus, the relative positions of the sensors 110, 1061, 1062 can define a plane (not shown). Tracking the movements of the plane corresponds to tracking the upper body movements of a user. The chest motion detection panel 110 can be used as a reference sensor and positioned proximal to a center of gravity of the user. The reference sensor 110 can then provide information relative to the movement of the other sensors 1061 and 1062. Incorporating movement information from the spaced-apart additional sensors 1061 and 1062, i.e. distal to the center of gravity and spaced-apart from sensor 110, will provide spatial movement detection of the user's upper body. In one exemplary illustration, spatial movement detection includes tracking movements relative to three axes intersecting at right angles at or near the center of gravity of the user. The three axes can include a first vertical axis (i.e. running head to toe), a second horizontal axis (i.e. running side to side), and a third horizontal axis (i.e. running front to rear). Similar to the three types of movement of an aircraft, the tracking of movements of the user can include tracking rotations in three dimensions: a first rotation, for example yaw, can include the upper body turning left or right about the first axis; a second rotation, for example pitch, can include the upper body moving up or down about the second axis; and, a third rotation, for example roll, can include the upper body rotating about the third axis.

FIG. 8 illustrates a block diagram of components of the gaming vest of the present invention in accordance with the disclosed architecture. The components 600 can comprise a right sensor panel 1061, a left sensor panel 1062 and a chest motion detection panel 110 having a plurality of motion sensors to detect upper body movements, such as chest and/or the shoulders of the user. The gaming vest 100 comprises other components 600 such as a wireless communication module 801 to connect the vest 100 wirelessly to any display screen or other electronic device. A processor 802 can be incorporated for processing the data collected by the sensors. A controller compiles the processed data, translates the movements and mimics the same motions to the on-screen character in the game. Further, a battery 803 is included in the gaming vest 100 structure to enable the operation of the vest 100. The vest 100 may be powered by NiMH batteries or any other type of batteries known in the state of the art. However, an NiMH battery has properties that reduce the probability of overheating and decrease recharging requirements, which makes them superior to lithium-ion or lithium polymer batteries (LiPo). Further, single use batteries or rechargeable batteries may be used in the device 100.

The realistic VR game system equipped with a wearable gaming vest 100 according to an embodiment of the present invention for achieving the above object can be worn by the user, and provides virtual reality experience based on the sensors equipped in the vest 100. The VR box 120 can also be used to reset the viewpoint of the virtual reality information according to the movement of the head of the user. In addition, the gaming vest 100, when worn by the user 130, allows the user to perform other tasks such as eating, etc. while playing the game.

The gaming vest 100 permits a video game to provide a total reality-mimicking experience by including complex and multiple sensors that are coordinated with the visual and audible signals received by the user 130. The games become more realistic as the motion and movements inside the game are stimulated by the movements of the player 130 and the reality is enhanced when the senses are stimulated in ways that accurately and completely reflect the total, multi-directional action occurring in the game. The vest 100 of the present invention also permits a player to receive stimuli from many directions at the same time, which further enhances the enjoyment of the game.

Therefore, it can be observed that the present invention provides a unique solution to the problem of providing a virtual reality control system for video games. One advantage of the gaming vest 100 of the present invention is that it provides multiple controlling features for the video game player. Additionally, the gaming vest 100 of the present invention allows the user to play games for a considerable amount of time and without discomfort. Finally, the gaming vest 100 of the present invention suitably provides users with an advanced system installed in a vest allowing players to have greater control of the motion of a video game via sensing elements.

The gaming vest 100 comprising the harness/frame and elongated belt can be of any color such as red, white, blue or any other color as per the needs and desires of the users. Logos, designs, prints, personalized slogans, sponsors, advertisements and more can also be printed on the body of the gaming vest 100 to provide an appealing and unique aesthetic look for the users. The harness/frame structure can be of a waterproof material to prevent any moisture damage to the integrated sensors (e.g., from the sweat of the wearer), battery, wireless communication module or other components of the gaming vest device 100.

Certain terms are used throughout the following description and claim to refer to a particular feature or component of the vest. As one skilled in the art will appreciate, different persons may refer to the same feature or component by different names. This document does not intend to distinguish between components or features that differ in name but not structure or function. As used herein “player” and “user” are interchangeable and refer to any person using the gaming vest 100 of present invention to play video games. Also, the terms “vest”, “harness”, “gaming vest”, “gaming and virtual reality control system”, “game controller”, “gaming vest device” and “virtual reality controller device” are interchangeable and refer to the gaming vest 100 of present invention.

Notwithstanding the forgoing, the gaming vest 100 of the present invention and its various structural components can be of any suitable size, shape, color, style and configuration as is known in the art without affecting the overall concept of the invention, provided that it accomplishes the above stated objectives. One of ordinary skill in the art will appreciate that the shape and size of the gaming vest 100 and its various components, as show in the FIGS. are for illustrative purposes only, and that many other shapes and sizes of the gaming vest 100 are well within the scope of the present disclosure. Although dimensions of the gaming vest 100 and its components i.e., length, width, and height are important design parameters for good performance, the gaming vest 100 of the present invention and its components may be of any shape, size, color and style that ensures optimal performance during use and/or that suits user need and/or preference.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A gaming vest configured to mimic bodily movement of a user, the gaming vest comprising:
a vest portion having a mounting surface;
a first sensor, a second sensor, and a third sensor spatially mounted apart from one another on said vest portion;
a relative position of said first sensor, said second sensor, and said third sensor forming a plane therein, wherein a movement of said plane corresponds to a movement of the user; and
a controller for transmitting said movement of said plane to a video game, wherein the movement of said plane mimics said movement of the user.

2. The gaming vest of claim 1, wherein said first sensor is proximal to a center of gravity of the user.

3. The gaming vest of claim 2, wherein said second sensor and said third sensor are distal to the center of gravity of the user.

4. The gaming vest of claim 3 further comprising a Bluetooth module for wireless communication to said video game.

5. The gaming vest of claim 4 further comprising a battery for powering said gaming vest.

6. The gaming vest of claim 5, wherein said battery is rechargeable.

7. The gaming vest of claim 6 further comprising an attachment mechanism for attaching said gaming vest to the user, wherein said attachment mechanism is selected from a group consisting of a snap, a button, a magnet and a hook and loop fastener.

8. A gaming vest configured to mimic bodily movement of a user, the gaming vest comprising:
a vest portion having a mounting surface;
a first sensor, a second sensor, and a third sensor spatially mounted apart from one another on said vest portion;
said first sensor proximal to a center of gravity of the user;
at least one of said second and said third sensor distal to the center of gravity of the user, wherein said second sensor and said third sensor are collinear; and
a controller for transmitting a movement of each of said first sensor, said second sensor, and said third sensor to a video game, wherein the movement of each of the first, second and third sensors mimics the bodily movement of the user.

9. The gaming vest of claim 8, wherein said first sensor, said second sensor, and said third sensor are coplanar.

10. The gaming vest of claim 9, wherein said coplanar movement corresponds to a group consisting of a rotational, a lateral, a forward, and a rearward movement of the user.

11. The gaming vest of claim 10, further comprising a Bluetooth module for wireless communication to said video game.

12. The gaming vest of claim 11, further comprising a battery for powering said gaming vest.

13. The gaming vest of claim 12, wherein said battery is rechargeable.

14. A method of mimicking a bodily movement of a user wearing a gaming vest, said method comprising the steps of:
securing said gaming vest over a shoulder and a chest of the user;
providing said gaming vest with a plurality of sensors including at least one sensor proximal to a center of gravity of the user and at least two sensors distal to the center of gravity of the user, wherein said plurality of sensors are spaced apart from one another and further defining a plane and further wherein said plane corresponds to an upper body movement of the user;
tracking said plane of said upper body movements of the user; and
transmitting wirelessly said plane of said upper body movements to a video game.

15. The method of claim 14, further comprising mimicking movements of said plane of said upper body movements to a character in said video game.

16. The method of claim 15, wherein said tracking of said upper body movement of the user includes tracking respective movement of said plane relative to a first, second and third axis, and further wherein the first, second and third axis intersect at right angles proximal to the center of gravity of the user,

17. The method of claim 16, wherein said tracking further comprises detecting a first yaw rotation about said first axis, a second pitch rotation about said second axis, and a third roll rotation about said third axis.

18. The method of claim 17, wherein said gaming vest further comprises a Bluetooth module for wireless connection to a remote device.

19. The method of claim 18, wherein said gaming vest further comprises a battery for powering said gaming vest.

20. The method of claim 19, wherein said battery is rechargeable.
